(19) United States
(12) Patent Application Publication
(10) Pub. No.: US 2026/0145502 A1
(43) Pub. Date: May 28, 2026

(54) Tonneau Cover Latch Handle Guard

(71) Applicant: Leer Group, Elkhart, IN (US)

(72) Inventor: Eugene A. Dylewski, II, Granger, IN (US)

(21) Appl. No.: 19/394,588

(22) Filed: Nov. 19, 2025

Related U.S. Application Data
(60) Provisional application No. 63/724,472, filed on Nov. 25, 2024.

(51) Int. Cl. B60J 7/19; B60J 7/14

(52) U.S. Cl. CPC B60J 7/198; B60J 7/141

(57) ABSTRACT

A tonneau cover is provided that includes at least one panel and a latch handle guard. The at least one panel composed of a top side, an underside, and a rear end. The underside of the at least one panel is configured to face an interior of a cargo box of a pickup truck when in a closed position. The rear end of the at least one panel is configured to be located adjacent to a tailgate of the cargo box of the pickup truck. The underside of the at least one panel includes at least one latch actuator. The latch handle guard is composed of a barrier plate. The barrier plate extends from the underside of the at least one panel of the tonneau cover adjacent the at least one latch actuator. The barrier plate is pivotally attached to the at least one panel between the at least one latch actuator and the rear end of the at least one panel.

### RELATED APPLICATIONS

The present Application relates to and claims priority to U.S. Provisional Patent Application, Ser. No. 63/724472, filed on Nov. 25, 2024, entitled “Tonneau Cover Latch Handle Guard.” The subject matter disclosed in that Provisional Application is hereby expressly incorporated into the present Application.

### TECHNICAL FIELD AND SUMMARY

The present disclosure relates to pickup trucks and, in particular, latch assembly guards for use on tonneau covers to protect them from unauthorized access.

Tonneau or truck bed covers provide a covering for a truck bed or cargo box when used in combination with its sidewalls and tailgate. Covering the bed of a pickup truck helps create a secure compartment where items may be stored out of view when the tailgate is in an upright and latched position. Embodiments of a tonneau cover may include a cover portion that is suspended over the truck bed between the sidewalls. A frame or rail assembly may be employed that attaches to the opposing sidewalls to secure the cover onto the cargo box.

Typically, tonneau covers include latching assemblies located on the underside of the tonneau cover when the tonneau cover is unfolded and laid flat over the cargo box. This makes the latching assemblies inaccessible when the tailgate is located in its upright and latched position, thereby preventing any unauthorized entry. When it is desired to open the tonneau cover, an operator typically opens and lowers the tailgate to allow access to the one or more latching assemblies underneath the tonneau cover. These latching assemblies can be activated to release latches that otherwise secure the tonneau cover to the cargo box sidewall. The operator is then able to open the tonneau cover and uncover the cargo box.

Often, the latching assembly is composed of a spring-biased cable suspended underneath the tonneau cover and attached to a latch. The cable is pulled by the operator, which draws on the latch, releasing it from a rail or other structure on the cargo box sidewall. This releases at least that portion of the tonneau cover from the cargo box. Preventing unauthorized access to this cable is accomplished by keeping the tailgate in its upright and latched condition. Only by lowering the tailgate can, theoretically, the cable be accessed. This means that only persons having a key to the tailgate should be able to access the cable underneath the tonneau cover for purposes of unlatching it.

While the cable is suspended underneath the tonneau cover, it serves as a convenient unlatching handle. This cable, however, may also be vulnerable to unauthorized persons who may still be able to access the cable without opening the tailgate. In particular, a coat hanger, other hooked structure, or instrument, can be inserted between the tailgate and the tonneau cover. The hooked portion can hook onto the cable and be pulled in a conventional manner to unlatch the tonneau cover without the tailgate being lowered.

To mitigate this security risk, an illustrative embodiment of the present disclosure provides a latch handle guard that extends from underneath the tonneau cover adjacent the unlatching cable. The guard may be an elongated strip barrier made of a rigid material like metal or plastic. The guard faces the seam between the tailgate and the end of the tonneau cover to serve as a barrier between a hook and the cable. This prevents a coat hanger, or other like instrument, from hooking onto, or otherwise engaging, the cable and allowing it to be pulled. It is appreciated that such a guard can be positioned adjacent each location of an unlatching cable on the underside of the tonneau cover that serves as a handle, which may be susceptible to engagement with a hooked structure. It will be appreciated from reading this disclosure that other unlatching handles may benefit from such a latch handle guard as well.

Accordingly, an illustrative embodiment of the present disclosure provides a tonneau cover comprising at least one panel and a latch handle guard. The at least one panel is composed of a top side, an underside, and a rear end. The underside of the at least one panel is configured to face an interior of a cargo box of a pickup truck when in a closed position. The rear end of the at least one panel is configured to be located adjacent to a tailgate of the cargo box of a pickup truck. The underside of the at least one panel includes at least one latch actuator. The latch handle guard extends from the underside of the at least one panel of the tonneau cover adjacent the at least one latch actuator. The latch handle guard is also located between the at least one latch actuator and the rear end of the at least one panel.

In the above and other illustrative embodiments, the tonneau cover may further comprise: the at least one latch actuator being selected from the group consisting of a cable, a handle, and pinch latch handles; the latch handle guard being an elongated strip barrier located along the underside of the at least one panel; the latch handle guard being selected from the group consisting of a metal and a plastic; the at least one latch actuator is a plurality of latch actuators, wherein a separate latch handle guard is located adjacent each of the plurality of latch actuators, wherein each of the plurality of latch actuators is located adjacent the rear end of the at least one panel, and wherein each of the separate latch handle guards is located between one of the plurality of latch actuators of the plurality of latch actuators and the rear end of the at least one panel; the at least one panel is a plurality of panels, wherein one panel of the plurality of panels is located adjacent the at least one panel, and wherein the at least one panel is configured to be located adjacent the tailgate; the at least one panel includes a frame, a portion of the frame is located at the rear end of the at least one panel, and wherein the latch handle guard is attached to the portion of the frame located at the rear end of the at least one panel; the latch handle guard is composed of a baseplate that is secured to the at least one panel and a barrier plate oriented transverse to the baseplate, wherein the barrier plate extends from the baseplate and the underside of the at least one panel of the tonneau cover adjacent the at least one latch actuator; the baseplate is secured to the at least one panel with at least one fastener; at least a portion of the latch handle guard extends from the at least one panel to an extent beyond the at least one latch actuator; and the barrier plate extends from the at least one panel to an extent beyond the at least one latch actuator.

Another illustrative embodiment of the present disclosure provides a tonneau cover comprising at least one panel and a latch handle guard. The at least one panel is composed of a top side, an underside, and a rear end. The underside of the at least one panel is configured to face an interior of a cargo box of a pickup truck when in a closed position. The rear end of the at least one panel is configured to be located adjacent to a tailgate of the cargo box of a pickup truck. The underside of the at least one panel includes at least one latch actuator. The latch handle guard extends from the underside of the at least one panel of the tonneau cover adjacent the at least one latch actuator. The latch handle guard includes a baseplate and a barrier plate. The barrier plate is positionable transverse to at least a portion of the baseplate. The barrier plate is pivotally attached to the baseplate. The barrier plate is located between the at least one latch actuator and the rear end of the at least one panel.

In the above and other illustrative embodiments, the tonneau cover may further comprise: the barrier plate being hingedly attached to the baseplate; the barrier plate including a partially cylindrical rod fitted within a channel formed in the portion of the baseplate; a second portion of the baseplate extending transversely from the at least one panel and includes the channel formed at an end of the second portion and receives the partially cylindrical rod of the barrier plate so that the barrier plate is pivotable with respect to the baseplate; the barrier plate including a finger located adjacent and spaced apart from the partially cylindrical rod, wherein the finger limits an extent to which the barrier plate pivots with respect to the baseplate; and the baseplate being attached to the at least one panel.

Another illustrative embodiment of the present disclosure provides a tonneau cover comprising at least one panel and a latch handle guard. The at least one panel is composed of a top side, an underside, and a rear end. The underside of the at least one panel is configured to face an interior of a cargo box of a pickup truck when in a closed position. The rear end of the at least one panel is configured to be located adjacent to the tailgate of the cargo box of a pickup truck. The underside of the at least one panel includes at least one latch actuator. The latch handle guard is composed of a barrier plate. The barrier plate extends from the underside of the at least one panel of the tonneau cover adjacent the at least one latch actuator. The barrier plate is pivotally attached to the at least one panel between the at least one latch actuator and the rear end of the at least one panel.

In the above and other illustrative embodiments, the tonneau cover may further comprise: the barrier plate being pivotally attached to the at least one panel with a fastener; and the barrier plate extending about a length of a lateral extent of the at least one panel.

Additional features and advantages of the latch handle guard will become apparent to those skilled in the art upon consideration of the following detailed descriptions of carrying out the latch handle guard as presently perceived.

### BRIEF DESCRIPTION OF THE DRAWINGS

The present disclosure will be described hereafter with reference to the attached drawings which are given as non-limiting examples only, in which:

FIG. 1 is a side detail cross-sectional view of a rear quadrant of a cargo box including a sidewall and a tailgate;

FIG. 2 is an interior upward-looking perspective detailed view of the rear portion of the cargo box;

FIG. 3 is another side detail cross-sectional view of the rear quadrant of the cargo box including the sidewall and the tailgate;

FIG. 4 is an isolated underside detail perspective view of a rear portion of a rear panel and a rear frame of the tonneau cover;

FIG. 5 is an underside, upward-looking, interior detail view of the rear panel, rear frame, and latch assembly of the tonneau cover;

FIG. 6 is another side detail cross-sectional view of the rear quadrant of the cargo box;

FIG. 7 is an isolated side sectional view of a rear portion of the tonneau cover;

FIG. 8 is another isolated side sectional view of a rear portion of the tonneau cover;

FIG. 9 is an upward-looking perspective detail view of the underside of the tonneau cover;

FIG. 10 is another upward looking perspective detail view of the underside of the tonneau cover;

FIG. 11 is a detail isolated perspective view of a rear portion of a tonneau cover;

FIG. 12 is an underside upward-looking detailed view of a portion of a rear panel and rear frame of the tonneau cover;

FIG. 13 is an underside upward-looking full view of the panel of the tonneau cover;

FIG. 14 is an underside upward-looking detail view of the panel of the tonneau cover;

FIG. 15 is an underside upward-looking full view of the panel of the tonneau cover;

FIG. 16 is an underside upward-looking detail view of the panel of the tonneau cover;

FIG. 17 is an underside upward-looking full view of the panel of the tonneau cover;

FIG. 18 is an underside upward-looking detail view of the panel of the tonneau cover;

FIG. 19 is a rearward perspective detail view from the interior of the cargo box including the tailgate and a tonneau cover;

FIG. 20 is a perspective detail view of a portion of the cargo box including a portion of the sidewall and the tailgate with a portion of a tonneau cover located on the cargo box 2

FIG. 21 is an isolated side sectional view of a portion of the tonneau cover with pivoting latch handle guard;

FIG. 22 is another isolated side sectional view of a portion of the tonneau cover with pivoting latch handle guard;

FIG. 23 is an upward looking perspective detail view of the underside of the tonneau cover; and

FIG. 24 is another upward looking perspective detail view of the underside of the tonneau cover.

Corresponding reference characters indicate corresponding parts throughout the several views. The exemplification set out herein illustrates embodiments of the tonneau cover latch handle guard, and such exemplification is not to be construed as limiting the scope of the tonneau cover latch handle guard in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

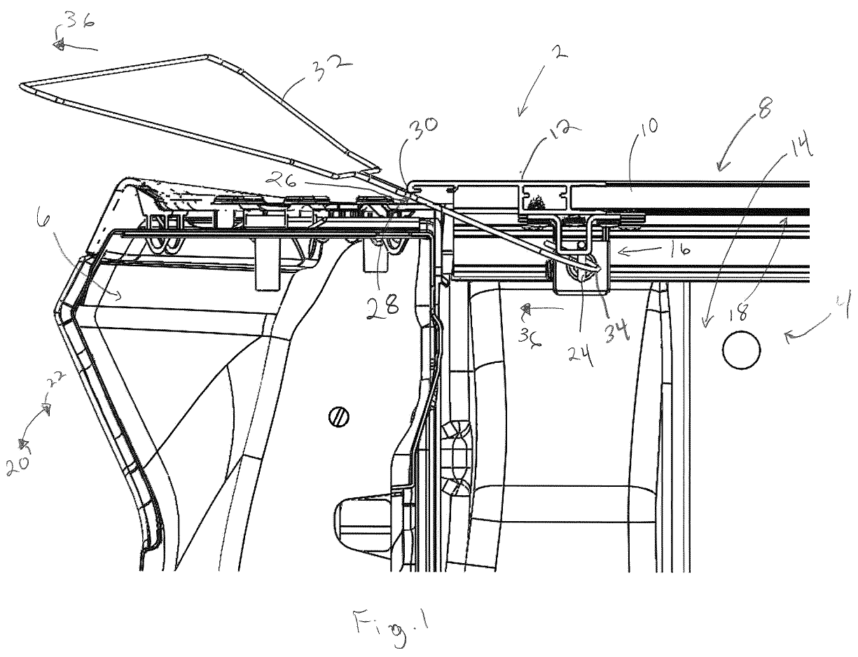

A side detail cross-sectional view of a rear quadrant of cargo box 2, including sidewall 4 and tailgate 6, is shown in FIG. 1. Here, tailgate 6 is located in its upright and latched position. A portion of tonneau cover 8, including rear panel 10 coupled to rear frame 12 shrouding interior 14 of cargo box 2, is also shown therein. As is conventional with such tonneau covers, a latch assembly 16 is located on underside 18 of tonneau cover 8 adjacent to or in the vicinity of tailgate 6. This is so that when tailgate 6 is pivoted downward in direction 20, interior 14 can be accessed by an operator. In several tonneau cover latching configurations, individual cover panels can release from cargo box 2 by pulling cable 24 in direction 36. Doing so releases latches, typically on each side of rear frame 12, as in this case, to pull away from the sidewalls, thereby releasing tonneau cover 8 from cargo box 2. Specifically, the operator can grasp cable 24, where pulling on same will cause latch assembly 16 to unlatch in order to release rear panel 10 of tonneau cover 8 from cargo box 2. Conversely, moving tailgate 6 in upward direction 22 to its closed and latched condition, as shown in this view, prevents access to latching assembly 16. This means that when tailgate 6 is locked, there is no access to interior 14 of cargo box 2, thereby preventing access to latching assembly 16.

A problem with this configuration, as also demonstrated in this view, is that a seam 26 exists between top surface 28 of tailgate 6 and trailing edge 30 of rear frame 12 of tonneau cover 8. Seam 26 may be large enough to allow a thin hooking instrument, such as a simple coat hanger 32, to fit between top surface 28 and trailing edge 30. This allows hook portion 34 of coat hanger 32 to have access to cable 24. With hook portion 34 able to fit around cable 24, as shown in FIG. 1, all that is required is to pull coat hanger 32 generally in direction 36, which is the same motion the operator would perform on cable 24, with tailgate 6 open, to unlatch latching assembly 16 from cargo box 2. In other words, a coat hanger may be employed to defeat the security measures provided by the combination of tonneau cover 8, with sidewalls 4 and tailgate 6, to gain access to interior 14 of cargo box 2.

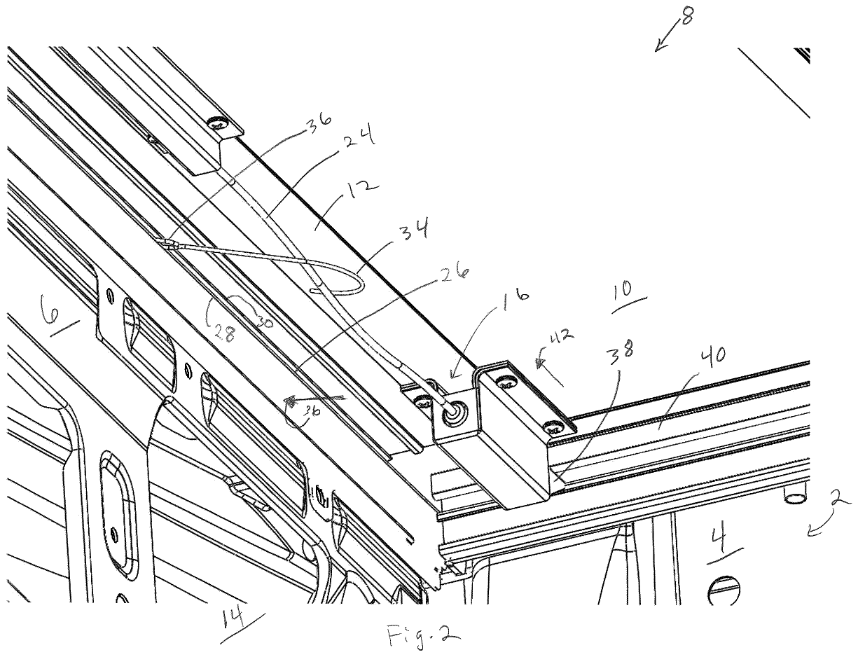

An interior, upward looking, perspective detailed view of a rear portion of cargo box 2 is shown in FIG. 2. This view is essentially from interior 14 looking upward and outward from cargo box 2. It is appreciated that latch 38 can be moved in direction 42 for purposes of releasing it from rail 40 when cable 24 is pulled in direction 36. This view, however, further demonstrates how hook portion 34 of coat hanger 32 can be inserted within seam 26, created between top surface 28 of tailgate 6 and trailing edge 30 of tonneau cover 8, to obtain access to interior 14 of cargo box 2. Hook portion 34, therefore, hooks onto cable 24 and when pulled in direction 36, can move latch 38 from rail 40, which is secured onto sidewall 4 of cargo box 2. This releases rear panel 10 of tonneau cover 8 from cargo box 2, thereby allowing access into interior 14 without ever moving tailgate 6. This appears to be a relatively easy way to defeat the security measures tonneau cover 8 provides when shrouding interior 14 of cargo box 2.

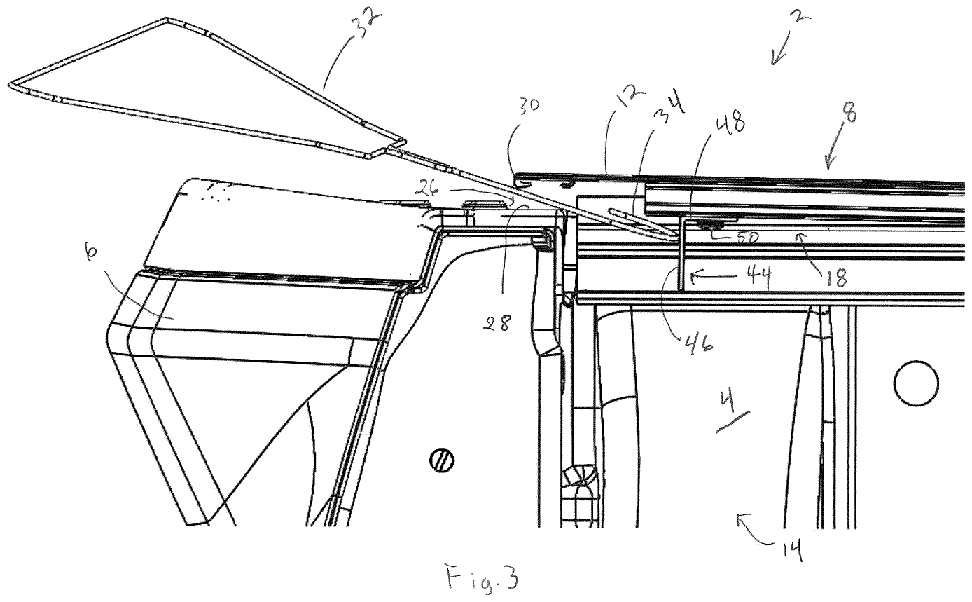

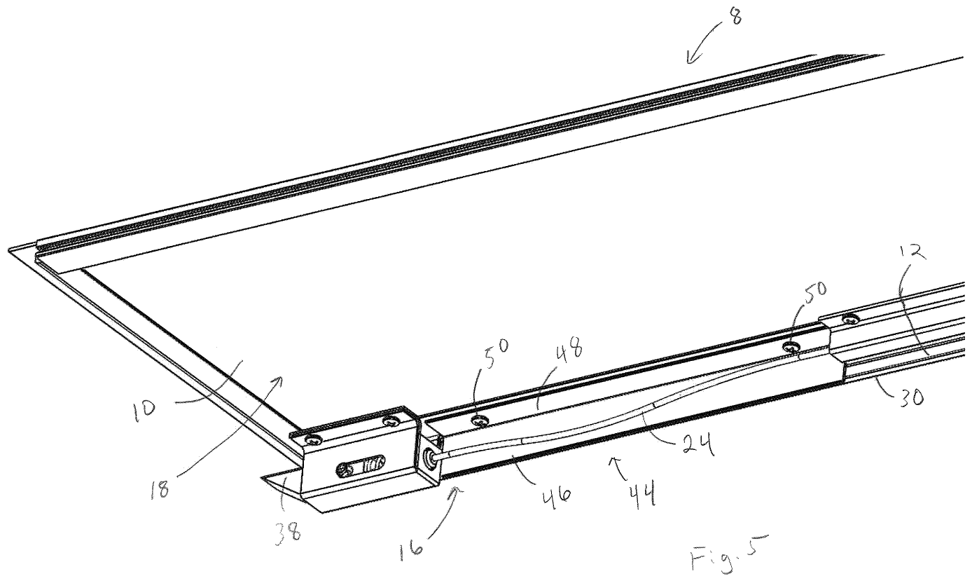

Another side detail cross-sectional view of the rear quadrant of cargo box 2, including sidewall 4 and tailgate 6, is shown in FIG. 3. Here, however, when coat hanger 32 is inserted into seam 26, between top surface 28 of tailgate 6 and trailing edge 30 of tonneau cover 8, hook portion 34 is limited to the extent it can be inserted into interior 14 of cargo box 2. This is because of latch handle guard 44 illustratively attached to rear frame 12 on underside 18 of tonneau cover 8. Latch handle guard 44 may illustratively compose a barrier plate 46 that extends downward from underside 18 into interior 14, via baseplate 48 illustratively attached to tonneau cover 8, via one or more fasteners 50. It will be appreciated by the skilled artisan upon reading this disclosure that latch handle guard 44 may be attached to any structure on tonneau cover 8 that helps facilitate a barrier for seam 26 to prevent objects like coat hanger 32 from being inserted into interior 14 and engaging latch assembly 16. In this view, and for purposes of clarity, latch assembly 16 has been removed (see, also, FIG. 6 to see the same view with latch assembly 16 included). In this current view, barrier plate 46 is shown extending downwardly. This provides a physical barrier in the vicinity of seam 26 and cable 24 that prevents hook portion 34 from engaging. In this way, inserting hooking or other like instruments between the tonneau cover and tailgate no longer have the same access to the latch assembly. This provides additional security for interior 14 of cargo box 2.

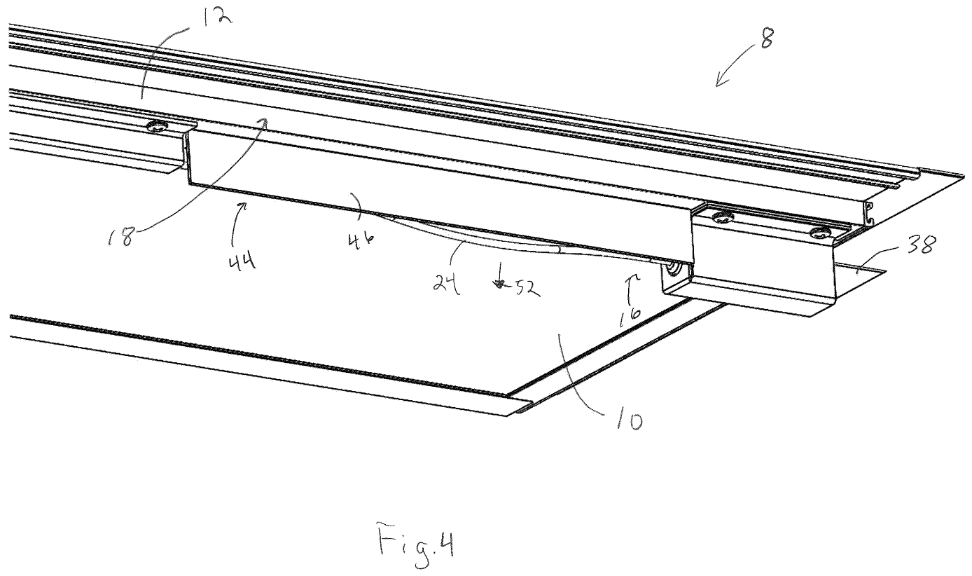

An isolated, underside detail perspective view of a rear portion of rear panel 10 and rear frame 12 of tonneau cover 8, is shown in FIG. 4. It is from this direction that an instrument like coat hanger 32 may come from to attempt to engage cable 24 in order to actuate latch 38 and release tonneau cover 8 from cargo box 2. This view demonstrates how barrier plate 46 of latch handle guard 44 shrouds a lateral extent of cable 24 serving as a physical barrier between cable 24 and anything that is inserted through seam 26 (see, also, FIG. 6). By depending downward from underside 18 of tonneau cover 8, barrier plate 46 provides a solid structure adjacent cable 24. It is appreciated from this view that the length and width of barrier plate 46 can be adjusted as needed to serve as an effective barrier between cable 24 and any instrument inserted into seam 26. It is also appreciated from this view that despite the presence of latch handle guard 44, an operator can still work around it and grasp cable 24, even if having to move same in a more downward direction 52 in order to release latch 38. It is further appreciated that from this view, despite a portion of cable 24 being visible, that is, by virtue of the upward looking underside view of tonneau cover 8, an instrument being inserted into seam 26 will be either above or at about the height of the cable reducing accessibility with latch handle guard 44 being positioned therebetween.

An underside, upward looking, interior detail view of rear panel 10, rear frame 12, and latch assembly 16 of tonneau cover 8, is shown in FIG. 5. This view is from the perspective of interior 14 of cargo box 2 looking rearward and upward towards latch assembly 16. This view depicts how latch handle guard 44 may be illustratively affixed onto rear frame 12 of tonneau cover 8. Illustratively, baseplate 48 is positioned transverse of barrier plate 46. One or more fasteners 50 may extend through both baseplate 48 and a portion of rear frame 12 in order to secure latch handle guard 44 onto tonneau cover 8. This view also demonstrates how barrier plate 46 depends downwardly from underside 18 of tonneau cover 8 to shroud cable 24 from trailing edge 30 of rear frame 12.

Another side detail cross-sectional view of the rear quadrant of cargo box 2, including sidewall 4 and tailgate 6, is shown in FIG. 6. A distinction in this view from that of FIG. 3 is that latch assembly 16 is included. As shown, and in contrast to FIGS. 1 and 2, hook portion 34, when inserted through seam 26, abuts barrier plate 46 of latch handle guard 44. This keeps hook portion 34 away from cable 24 of latch assembly 16. Because coat hanger 32 can no longer be employed to release latch assembly 16, tonneau cover 8 remains in its closed and latched position over interior 14 of cargo box 2.

Another illustrative embodiment of the present disclosure provides a latch handle guard, similar to that described in FIGS. 3-7, in that, a barrier panel is positioned between cable 24 and an access point, such as seam 26. In this new embodiment, however, the barrier plate is pivotal with respect to the baseplate. When a coat hanger or other instrument pushes against a pivotal barrier plate, that instrument is directed downward when pushed further into the interior of the cargo box. The coat hanger's downward movement is moving it away from cable 24, making engaging same more difficult.

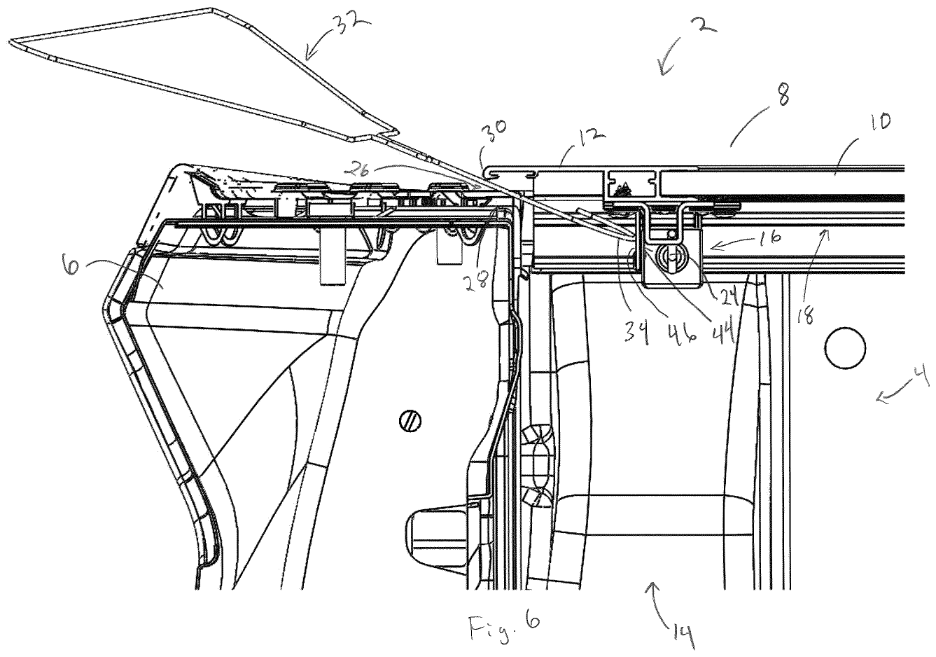

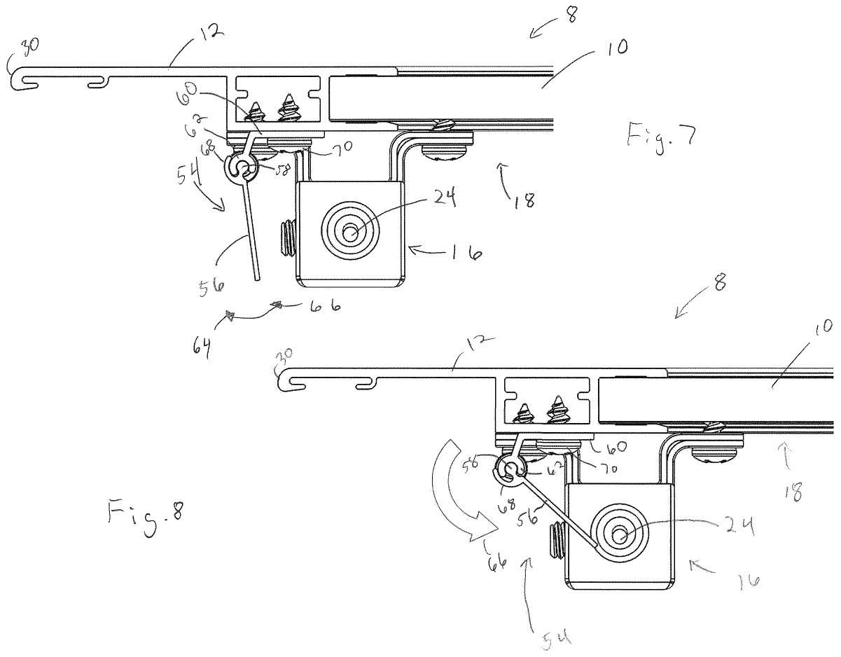

An isolated, side sectional view of a portion of tonneau cover 8 is shown in FIGS. 7 and 8. The view in FIG. 7 depicts rear frame 12 and rear panel 10 with latch assembly 16 located on underside 18 of tonneau cover 8. Cable 24 is shown extending from a portion of latch assembly 16. This view also shows movable latch handle guard 54 extending downward from underside 18 of tonneau cover 8. In this illustrative embodiment, barrier plate 56 includes partially cylindrical rod 58 that fits into a corresponding channel 62 of base 60. This allows barrier plate 56 to pivot in directions 64 and 66 with respect to base 60. Finger 68, on barrier plate 56, assists in keeping cylindrical rod 58 fitted within channel 62. One or more fasteners 70 are illustratively disposed through both base 60 and into rear frame 12 to secure same together and hold barrier plate 56 with respect to base 60.

The similar view of tonneau cover 8, shown in FIG. 8, includes movable latch handle guard 54 with barrier plate 56 pivoted in direction 66. This view demonstrates how cylindrical rod 58 of barrier plate 56 pivots within channel 62 of base 60. This makes it more difficult for an instrument to acquire access to cable 24. Again, this is because movement of barrier plate 56 assists in directing the instrument downward away from cable 24. As shown in this view, barrier plate 56 is further supported by finger 68 located adjacent to the exterior of channel 62.

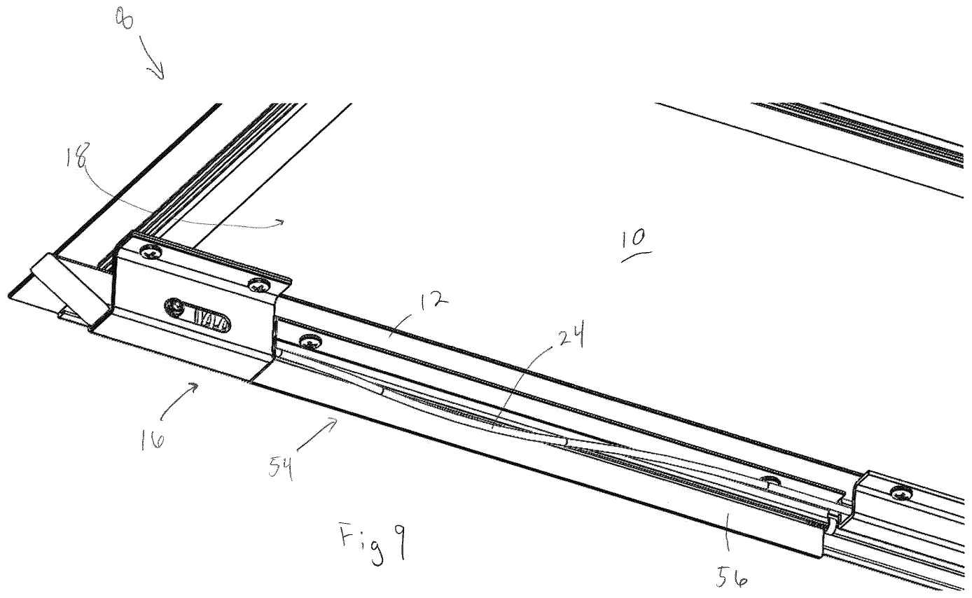

Upward looking perspective detail views of the underside of tonneau cover 8 are shown in FIGS. 9 and 10. These views both show latch handle guard 54 attached to rear frame 12 of tonneau cover 8. The view in FIG. 9 depicts barrier plate 56 extending downward from underside 18 of tonneau cover 8 to shroud cable 24 of latch assembly 16. This view also demonstrates how barrier plate 56 serves as a barrier between cable 24 and seam 26, as shown, for example, in FIGS. 1, 2, 3, and 6. This view further depicts barrier plate 56 in a position commensurate with the position of barrier plate 56 shown in FIG. 7.

Similarly, the view in FIG. 10 shows barrier plate 56, but pushed towards cable 24, in direction 66, like that shown in FIG. 8. In either instance, latch handle guard 54 still protects cable 24 from unauthorized access while at the same making cable 24 available for grasping by an authorized operator when tailgate 6 is in its lowered position.

Another illustrative embodiment of the present disclosure provides a latch handle guard configured to serve as a barrier to inhibit unauthorized access to handles of a pinch latch assembly. In this case, a different part of a coat hanger, or like device, may be used to fit in the seam between the end of the tonneau cover and the tailgate in an attempt to obtain access to the pinch handles. In an effort to frustrate that access, a latch handle guard can be placed adjacent to the latch handles, thereby preventing such unauthorized access rearward of the tonneau cover while at the same time allowing authorized access to the pinch handles by the operator when the tailgate is lowered.

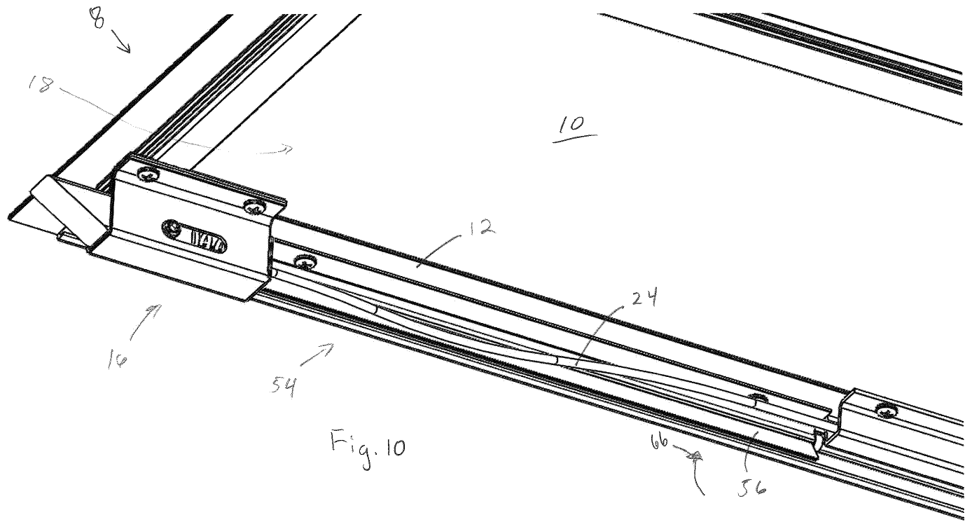

A detail isolated perspective view of a rear portion of a tonneau cover 78 is shown in FIG. 11. This view shows a portion of latch assembly 80, including latch 82, as well as first and second pinch latch handles 84 and 86. By pressing first and second pinch latch handles 84 and 86 in opposed directions 88 and 90, respectively, thereby moving pinch latch handles 84 and 86 towards each other, latch 82 (as well as a latch on the opposite side of tonneau cover 78), releases panel 92 from a cargo box, such as cargo box 2 shown in previous figures. A latch handle guard 94 is attached to rear frame 13, illustratively, via fastener 96. It is appreciated that in some embodiments, the rearmost (i.e., tailgate end) panel of a tonneau cover may include a lifting handle or other like structure, such as lifting handle 302 shown in FIG. 27 of U.S. Pat. No. 11,299,021, herein incorporated by reference in its entirety. Such lift handles are designed to make unfolding the rearmost panel easier since it is otherwise lying flat on top of the cover's adjacent panel. In an illustrative embodiment, that lifting handle can be removed and latch handle guard 94 installed in its place in order to accomplish two functions. First, barrier plate 98 of latch handle guard 94 can serve its named purpose as a barrier for pinch latch handles 84 and 86 from an instrument entering any seam (such as seam 26 shown in prior figures) between the end of the tonneau cover and the top of the tailgate. Second, because of the latch handle guard's design extending from the underside of tonneau cover 78, when in the flat shrouding use position, when panel 92 is folded onto an adjacent panel, barrier plate 98 can be used as an impromptu lifting handle or tab. In the embodiment shown, baseplate 100 is illustratively configured to fit adjacent both latch channel 102 and illustrative cylindrical portion 104 of rear frame 13. Fastener 96 illustratively fits into cylindrical portion 104 and can secure into baseplate 100 of latch handle guard 94, thereby securing same to rear frame 13. It is further appreciated that such securement can be made at both lateral ends of rear frame 13.

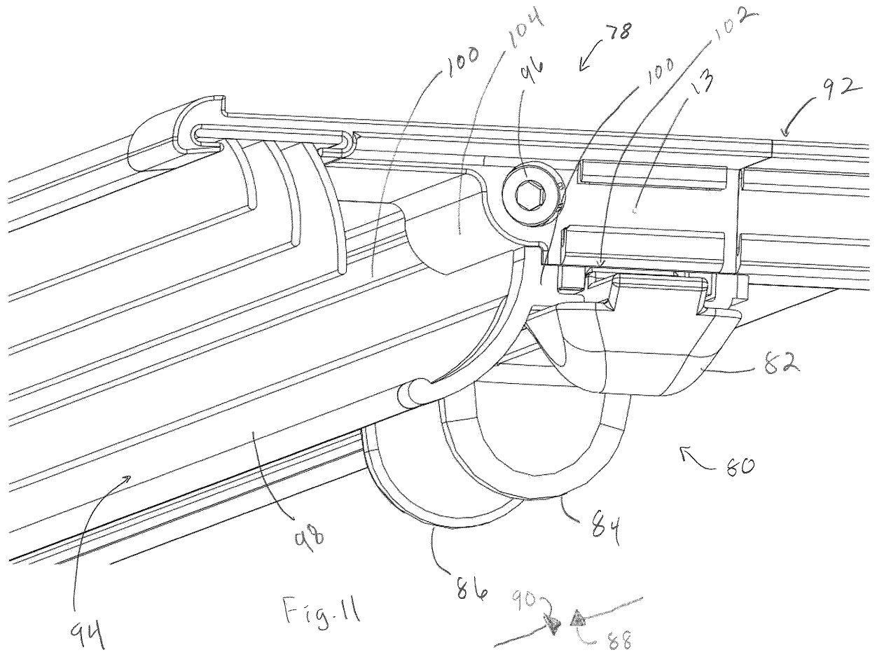

An underside, upward looking, detailed view of a portion of rear panel 10 and rear frame 13 of tonneau cover 78, is shown in FIG. 12. This view demonstrates how barrier plate 98 of latch handle guard 94 shields first pinch latch handle 84 and second pinch latch handle 86 from the rear where a seam between tonneau cover 78 and the tailgate, such as tailgate 6 (see, also, FIGS. 1-3 and 6), would be located. Barrier plate 98 extends laterally across rear frame 13 to fully block first and second pinch latch handles 84 and 86, respectively, while still allowing access by hand when the tailgate is in its lowered position providing proper access to latch assembly 80.

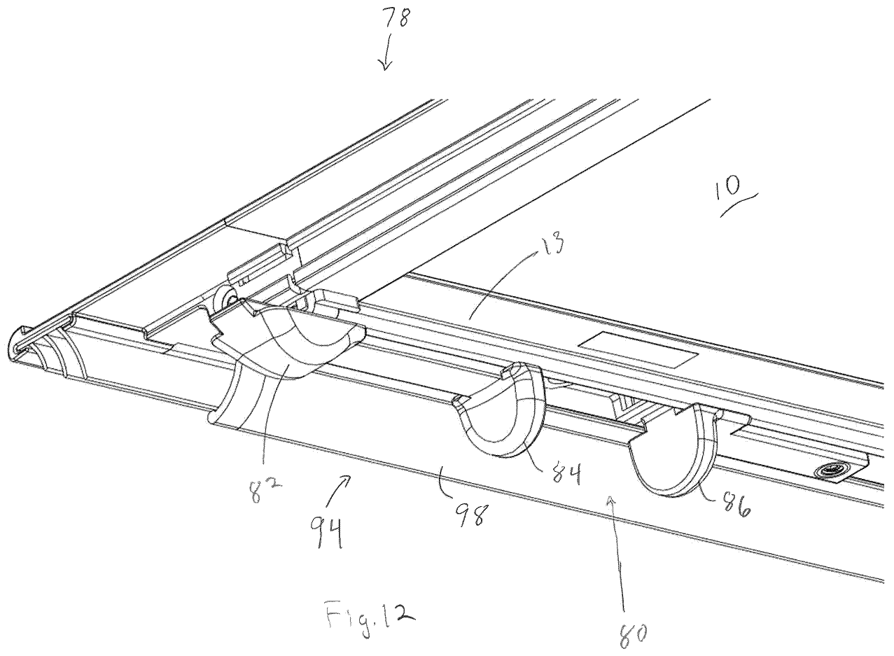

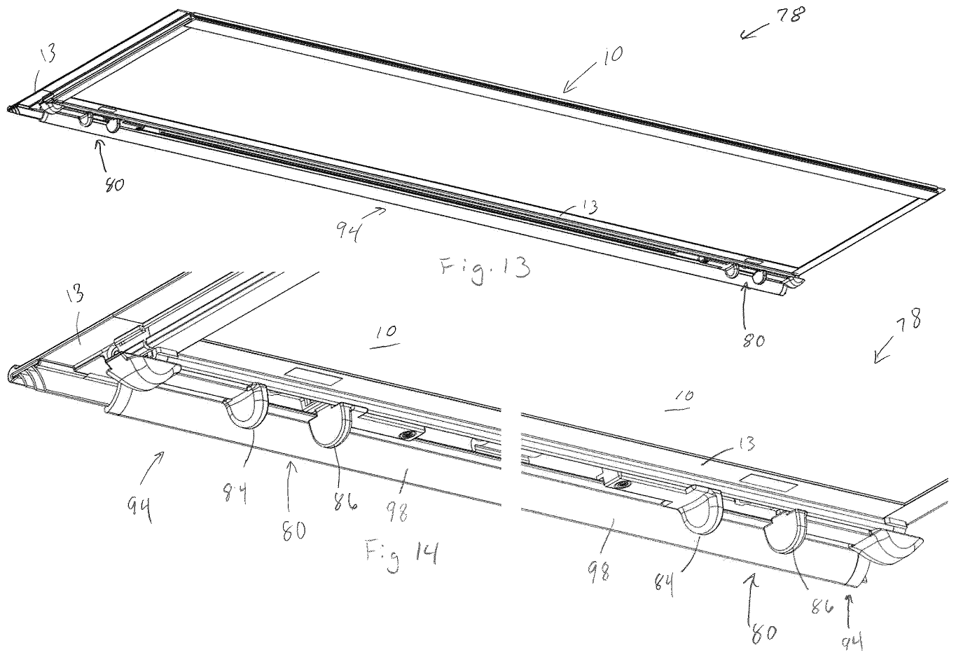

An underside, upward looking, full view of panel 10 of tonneau cover 78 is shown in FIG. 13. This view shows latch assemblies 80 located at each lateral end of rear frame 13. In this illustrative embodiment, latch handle guard 94 extends essentially the length of the lateral extent of rear panel 10 or at least past both latch assemblies 80 located on each end of rear frame 13. A similar view is shown in FIG. 14, except that only the lateral end portions of rear panel 10, where each latch assembly 80 is located, are shown. In this view, it is appreciated how both first and second pinch latch handles 84 and 86, on each side of rear panel 10, are shrouded by barrier plate 98 located rearward of latch assemblies 80. When rear panel 10 is fitted on top of a cargo box, barrier plate 98 extends substantially the lateral length of the cargo box, which can serve to frustrate attempts to access first and second pinch latch handles 84 and 86, respectively, along any point of the seam between rear frame 13 and the tailgate, such as tailgate 6 (see, also, FIGS. 1-3 and 6). It is appreciated that latch handle guard 94 may be made of one component or multiple components. In either case, latch handle guard 94 is attached to rear frame 13 via fasteners or other like means at the lateral ends like that shown in FIG. 11.

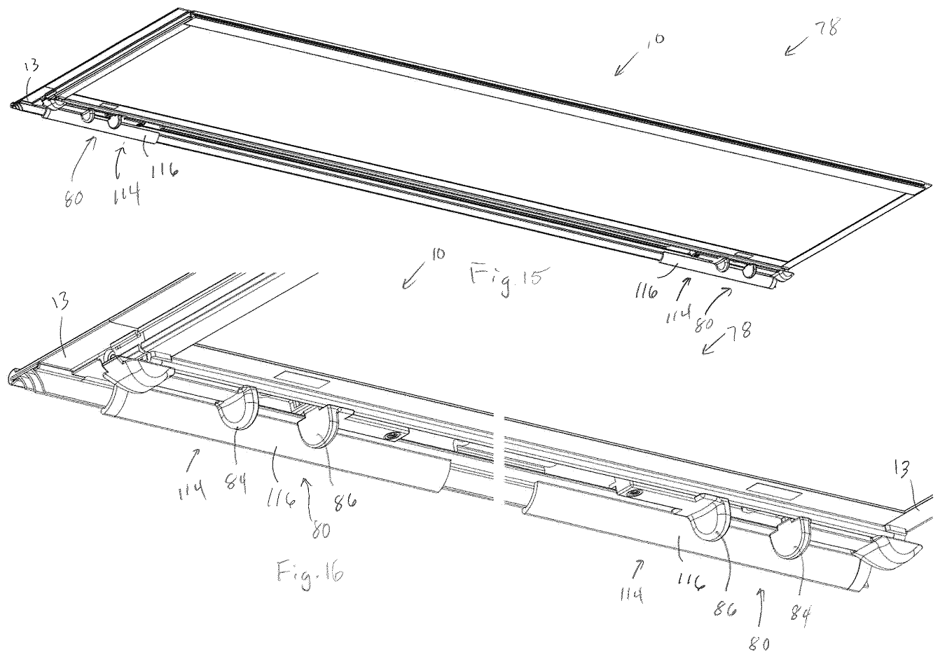

Similar views as that shown in FIGS. 13 and 14 of rear panel 10 are also shown in FIGS. 15 and 16. In these views, rear panels 10 are the same except that latch handle guard 94 extends essentially the lateral length of rear panel 10 and has been replaced with individual latch handle guards 114 positioned adjacent each of latch assemblies 80 located adjacent the lateral ends of rear panel 10 and rear frame 13. In this embodiment, latch handle guard 94 that extends the lateral length of the panel or frame is replaced with a shorter latch handle guard 114 that has a barrier plate 116 positioned adjacent each latch assembly 80 located adjacent to the lateral end of rear panel 10 and rear frame 13. It is appreciated from these views that latch handle guard 114 may be attached to rear frame 13 at each lateral end via any means described herein that attaches a latch handle guard to the tonneau cover, as well as attaching to frame 13, similar to that shown in FIG. 11. The views in FIGS. 15 and 16 also make clear that barrier plates 116, located adjacent first and second pinch latch handles 84 and 86, respectively, still serve as a barrier for those handles, even if it is desired not to have the latch handle guard extend all the way across the lateral extent of panel 10.

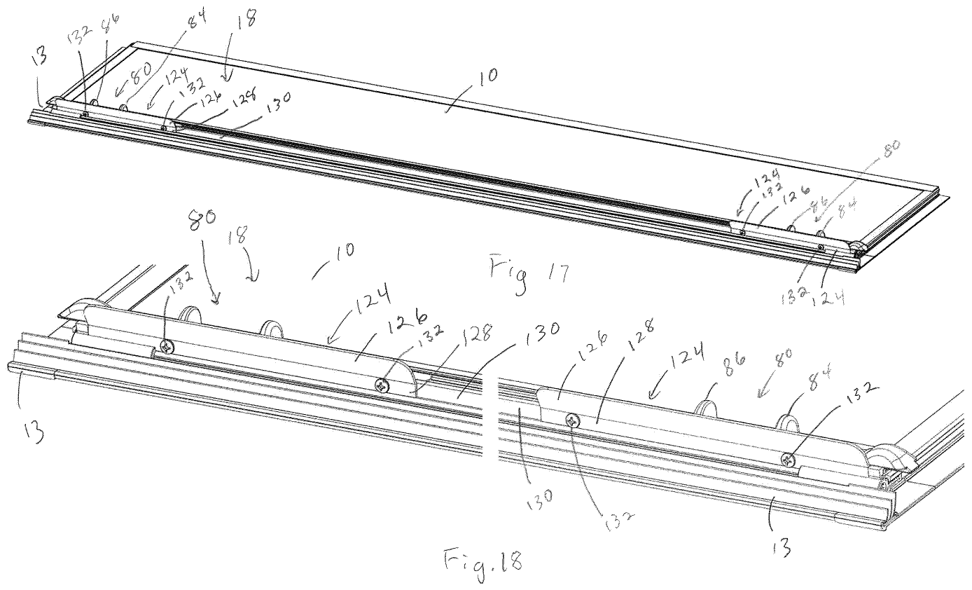

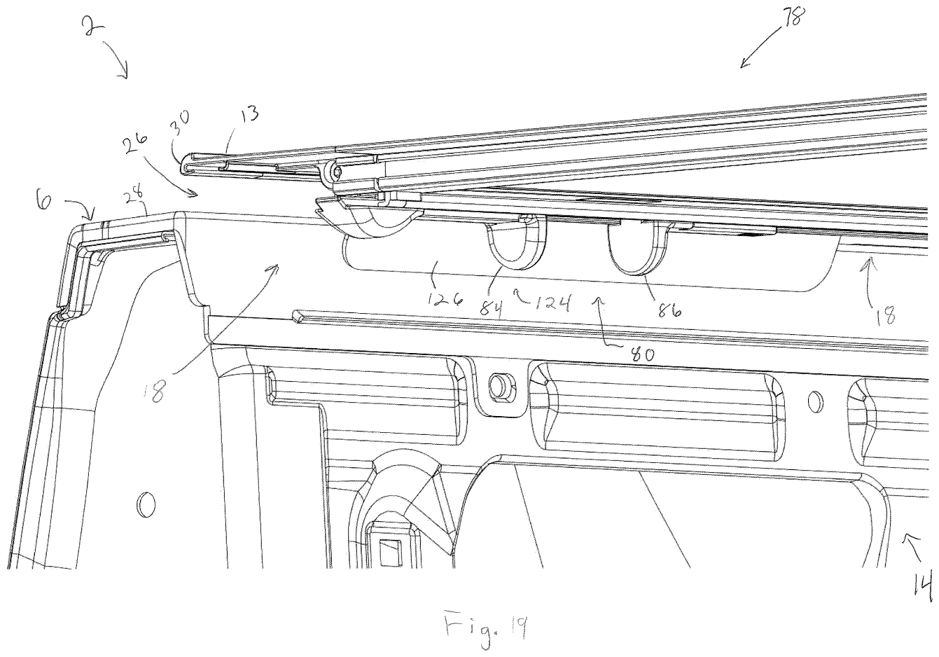

Another illustrative embodiment of the present disclosure provides latch handle guards, such as latch handle guards 124, shown in FIGS. 17 and 18. In this embodiment, barrier plates 126 extend from underside 18 of rear panel 10 serving as an obstacle for any instruments that would be inserted through a seam at the tailgate end of a cargo box. This embodiment is further simplified in that baseplates 128 are fastened to the side of channel 130 of latch assemblies 80 using fasteners 132 as illustratively shown. This is a simpler design that can be affixed to existing tonneau covers that have a depending structure extending from the underside of the rear section of the tonneau cover. Fasteners 132 can be tapped into such structures to provide latch handle guards 124 for latch handles that otherwise have no such protection. It is further appreciated by the skilled artisan upon reading this disclosure that such latch handle guard 124 may be used with tonneau covers having a variety of latch handle configurations, including cable pull latching assemblies, such as latch assembly 16 shown in a prior embodiment.

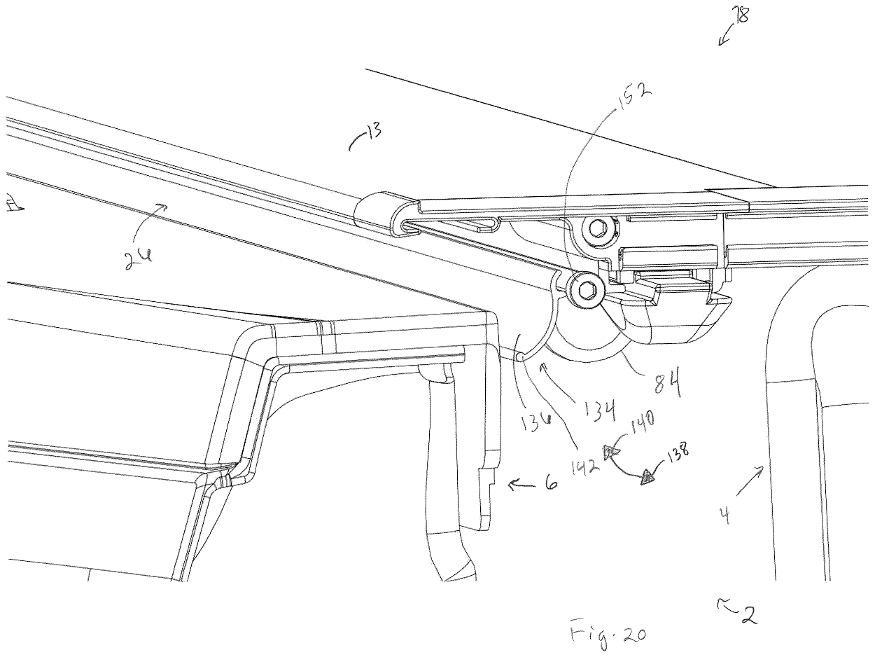

A rearward, perspective, detail view from interior 14 of cargo box 2, including tailgate 6 and tonneau cover 78, is shown and FIG. 19. This view demonstrates how barrier plate 126 of latch handle guard 124 extends downward into interior 14 of cargo box 2 to serve as an obstacle between first and second pinch latch handles 84 and 86, respectively, and seam 26 created between tailgate 6 and tonneau cover 78. When trailing edge 30 of rear frame 13 is located on top surface 28 of tailgate 6, seam 26 will still exist. As discussed in prior embodiments, using an instrument, such as coat hanger 32 or the like, to insert within seam 26 to engage pinch latch handles 84 and 86, is thwarted by barrier plate 126 extending downward from underside 18 of tonneau cover 78. Preventing this access reduces the potential for that instrument to engage latch assembly 80 to move same and unlatch tonneau cover 78.

Another illustrative embodiment of the present disclosure provides a pivoting latch handle guard similar to the pivoting latch handle guards of the prior embodiments. To that end, this pivoting latch handle guard can be pushed inward towards latch assembly 80 when engaged by an instrument such as a coat hanger. This moves the barrier plate of the latch handle guard inward, thereby causing the instrument to move downward away from the latch assembly, or in this case, the pinch latch handles further creating difficulty and frustrating the ability to get to the handles that move the latch.

A perspective detail view of a portion of the cargo box, including a portion of sidewall 4 and tailgate 6 with a portion of tonneau cover 78 located on cargo box 2, is shown in FIG. 20. This view demonstrates how seam 26, between tonneau cover 78 and tailgate 6, can be obstructed by pivoting latch handle guard 134. As shown, barrier plate 136 of pivoting latch handle guard 134 is specifically directed towards seam 26 creating the obstacle between it and pinch latch handle 84 (and pinch latch handle 86, not shown in this view). By shrouding seam 26 therewithin prevents contact with the latch handles. In this case, with barrier plate 136 pivotable in directions 138 and 140, placing that instrument against barrier plate 136 causes the instrument to pivot barrier plate 136 in direction 138 forcing the instrument downward instead of towards the pinch latch handles. An illustrative upturn 142 may serve as both an additional gripping surface for an authorized user to employ pivoting latch handle guard 134 as a lifting handle, but also to serve as a stop against an instrument pushing against barrier plate 136 when inserted into seam 26.

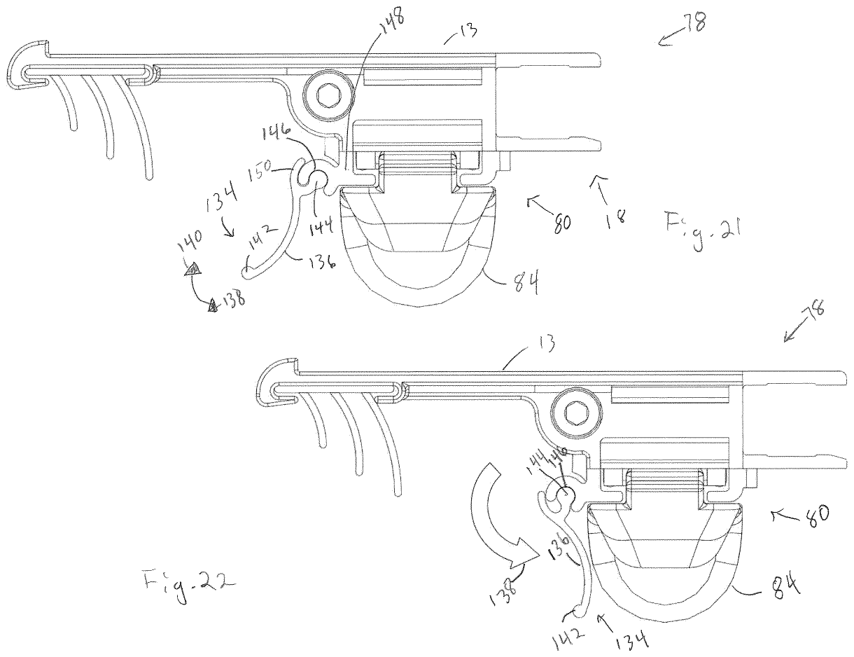

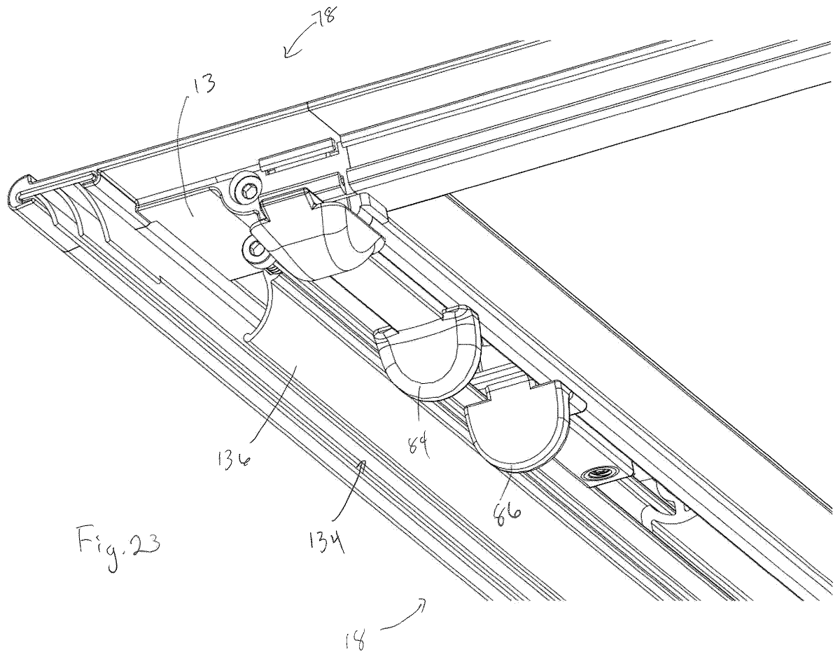

Isolated side sectional views of a portion of tonneau cover 78, with pivoting latch handle guard 134, are shown in both FIGS. 21 and 22. The view in FIG. 21 depicts rear frame 13 with latch assembly 80 located on underside 18 of rear frame 13. Pinch latch handle 84 is shown extending downwardly from a portion of latch assembly 80. In this illustrative embodiment, barrier plate 136 includes a partially cylindrical rod 144 that fits into a corresponding channel 146 of base 148 so that barrier plate 136 can pivot in directions 138 and 140 with respect to base 148. Finger 150 on barrier plate 136 assists keeping cylindrical rod 144 fitted within channel 146. One or more fasteners 152 (see FIG. 20) are illustratively employed to keep cylindrical rod 144 within channel 146 to secure barrier plate 136 within channel 146. The similar view shown in FIG. 22 demonstrates what happens when an instrument engages barrier plate 136. As shown, barrier plate 136 pivots via pivoting cylindrical rod 144 within channel 146 in direction 138 to further frustrate the ability of an instrument from engaging pinch latch handle 84 (as well as pinch latch handle 86 not shown in this view), thereby preventing same from being moved to unlatch latch assembly 80. This view also shows upturned portion 142, which can further function as an obstacle, as well as a lifting handle for tonneau cover 78.

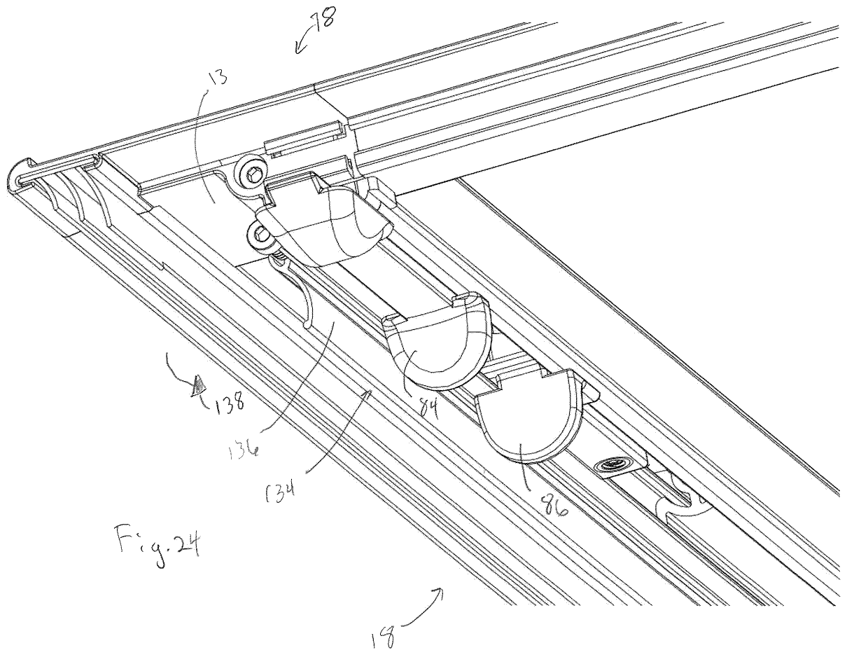

Upward looking, perspective, detail views of the underside of tonneau cover 8 are shown in FIGS. 23 and 24. Both views depict pivoting latch handle guard 134 attached to rear frame 13 of tonneau cover 78. The view in FIG. 23 shows barrier plate 136 extending downward from underside 18 of tonneau cover 8 to shroud pinch latch handles 84 and 86. This view demonstrates how barrier plate 136 serves as an obstruction between those pinch latch handles 84 and 86 and seam 26 as shown in FIG. 20. This view also shows barrier plate 136 extending downward. Similarly, the view in FIG. 24 depicts barrier plate 136 pivoted in direction 138 towards pinch latch handles 84 and 86. Further, this view demonstrates that pinch latch handles 84 and 86 are still available to be grasped by an authorized user when tailgate 6 is lowered to acquire access into interior 14 of cargo box 2.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed

1. A tonneau cover comprising:
at least one panel composed of a top side, an underside, and a rear end;
wherein the underside of the at least one panel is configured to face an interior of a cargo box of a pickup truck when in a closed position;
wherein the rear end of the at least one panel is configured to be located adjacent to a tailgate of the cargo box of the pickup truck;
wherein the underside of the at least one panel includes at least one latch actuator; and
a latch handle guard that extends from the underside of the at least one panel of the tonneau cover adjacent the at least one latch actuator;
wherein the latch handle guard is also located between the at least one latch actuator and the rear end of the at least one panel.

2. The tonneau cover of claim 1, wherein the at least one latch actuator is selected from the group consisting of a cable, a handle, and pinch latch handles.

3. The tonneau cover of claim 1, wherein the latch handle guard is an elongated strip barrier located along the underside of the at least one panel.

4. The tonneau cover of claim 1, wherein the latch handle guard is selected from the group consisting of a metal and a plastic.

5. The tonneau cover of claim 1, wherein the at least one latch actuator is a plurality of latch actuators, wherein a separate latch handle guard is located adjacent each of the plurality of latch actuators, wherein each of the plurality of latch actuators is located adjacent the rear end of the at least one panel, and wherein each of the separate latch handle guards is located between one of the plurality of latch actuators of the plurality of latch actuators and the rear end of the at least one panel.

6. The tonneau cover of claim 1, wherein the at least one panel is a plurality of panels, wherein one panel of the plurality of panels is located adjacent the at least one panel, and wherein the at least one panel is configured to be located adjacent the tailgate.

7. The tonneau cover of claim 1, wherein the at least one panel includes a frame, a portion of the frame is located at the rear end of the at least one panel, and wherein the latch handle guard is attached to the portion of the frame located at the rear end of the at least one panel.

8. The tonneau cover of claim 1, wherein the latch handle guard is composed of a baseplate that is secured to the at least one panel and a barrier plate oriented transverse to the baseplate, wherein the barrier plate extends from the baseplate and the underside of the at least one panel of the tonneau cover adjacent the at least one latch actuator.

9. The tonneau cover of claim 8, wherein the baseplate is secured to the at least one panel with at least one fastener.

10. The tonneau cover of claim 1, wherein at least a portion of the latch handle guard extends from the at least one panel to an extent beyond the at least one latch actuator.

11. The tonneau cover of claim 8, wherein the barrier plate extends from the at least one panel to an extent beyond the at least one latch actuator.

12. A tonneau cover comprising:
at least one panel composed of a top side, an underside, and a rear end;
wherein the underside of the at least one panel is configured to face an interior of a cargo box of a pickup truck when in a closed position;
wherein the rear end of the at least one panel is configured to be located adjacent to a tailgate of the cargo box of a pickup truck;
wherein the underside of the at least one panel includes at least one latch actuator; and
a latch handle guard that extends from the underside of the at least one panel of the tonneau cover adjacent the at least one latch actuator;
wherein the latch handle guard includes a baseplate and a barrier plate;
wherein the barrier plate is positionable transverse to at least a portion of the baseplate;
wherein the barrier plate is pivotally attached to the baseplate; and
wherein the barrier plate is located between the at least one latch actuator and the rear end of the at least one panel.

13. The tonneau cover of claim 12, wherein the barrier plate is hingedly attached to the baseplate.

14. The tonneau cover of claim 12, wherein the barrier plate includes a partially cylindrical rod fitted within a channel formed in the portion of the baseplate.

15. The tonneau cover of claim 14, wherein a second portion of the baseplate extends transversely from the at least one panel and includes the channel formed at an end of the second portion and receives the partially cylindrical rod of the barrier plate so the barrier plate is pivotable with respect to the baseplate.

16. The tonneau cover of claim 15, wherein the barrier plate includes a finger located adjacent and spaced apart from the partially cylindrical rod, wherein the finger limits an extent to which the barrier plate pivots with respect to the baseplate.

17. The tonneau cover of claim 12, wherein the baseplate is attached to the at least one panel.

18. A tonneau cover comprising:
at least one panel composed of a top side, an underside, and a rear end;
wherein the underside of the at least one panel is configured to face an interior of a cargo box of a pickup truck when in a closed position;
wherein the rear end of the at least one panel is configured to be located adjacent to a tailgate of the cargo box of the pickup truck;
wherein the underside of the at least one panel includes at least one latch actuator; and
a latch handle guard composed of a barrier plate;
wherein the barrier plate extends from the underside of the at least one panel of the tonneau cover adjacent the at least one latch actuator; and
wherein the barrier plate is pivotally attached to the at least one panel between the at least one latch actuator and the rear end of the at least one panel.

19. The tonneau cover of claim 18, wherein the barrier plate is pivotally attached to the at least one panel with a fastener.

20. The tonneau cover of claim 18, wherein the barrier plate extends about a length of a lateral extent of the at least one panel.
